(19) United States
(12) Patent Application Publication
(10) Pub. No.: US 2003/0131893 A1
(43) Pub. Date: Jul. 17, 2003

(54) Complex valve assembly for hydraulic circuits, in particular for the power unit

(76) Inventor: Luca Ibatici, Rivalta (IT)

Correspondence Address: BROWDY AND NEIMARK, P.L.L.C., 624 NINTH STREET, NW, SUITE 300, WASHINGTON, DC, 20001-5303, US

(21) Appl. No.: 10/337,313

(22) Filed: Jan. 7, 2003

(30) Foreign Application Priority Data
Jan. 11, 2002 (IT) RE2002A000002

(51) Int. Cl. F15B 13/043

(52) U.S. Cl. 137/596.12

(57) ABSTRACT

The valve assembly of the invention comprises a one-piece body (10) having in its interior a single main axial cylindrical cavity (11) of rectilinear axis, communicating via an outer mouth with at least one outer face (10a) of the one-piece body (10), and first channels (13, 14, 14′, 15) communicating with said main cavity (11) and connected to the delivery side (13) of a liquid pressurizing pump, to the discharge, and to at least one user take-off (16) respectively; inserted into the one-piece body (10), a cylindrical cartridge (20) having an axial second cavity (21) coaxial with the main cavity (11), which cartridge engages the surface of the main cavity (11) and is arranged to create, between its own cylindrical outer surface and the surface of the main cavity (11), passages providing communication between said first channels (13, 14, 14′, 15); valve elements (E1-E4), inserted into the second cavity (21) and arranged to define, in combination with this latter, at least two or more valves with different functions, chosen from the following: non-return valve (V1), flow regulator valve (V2), discharge valve (V3) and maximum pressure valve (V4).

This invention relates to a complex valve assembly for hydraulic circuits, in particular for the power unit or for forming in-line blocks. With regard to the power unit, this usually consists of a very compact unit comprising an oil pump, an electric motor for operating the pump, a reservoir for the oil in which the pump is immersed, and a one-piece body which rigidly joins together the motor, pump and reservoir.

In addition, the body of the power unit carries within its interior various valves forming part of the hydraulic circuit which connects the delivery and the discharge to the user means (usually a hydraulic actuator), namely the non-return valve, the discharge valve, the flow regulator valve and the maximum pressure valve.

Connecting said valves together is rather complicated, the inner shape of the body being likewise complex because of the various housings for suitably carrying the various valves and the relative connections. The manufacture of the body is consequently correspondingly complicated.

The same technical problem generally arises for bodies carrying said valves to form a hydraulic circuit, even if independent of the pump and motor.

An object of this invention is to simplify the production of said bodies, in particular by simplifying the die-casting mould, reducing the number of components, reducing the number of machining operations on the casting, and reducing the time for mounting the valves onto the body. This and other objects are attained by the invention as characterised in the claims.

The valve assembly according to the invention comprises a one-piece body, in the interior of which there is formed a single axial cylindrical main cavity, communicating via an outer mouth with at least one outer face of the body, and first channels communicating with said main cavity and arranged to be connected to the delivery side of a liquid pressurizing pump, to the discharge and to at least one user take-off respectively. In the interior of the one-piece body there is positioned a cylindrical cartridge having an axial second cavity coaxial with the main cavity, which cartridge engages the surface of the main cavity and is arranged to create, between its own outer surface and the surface of the main cavity, passages providing communication between said first channels; valve elements are also provided, inserted into said second cavity and arranged to define, in combination with this latter, at least two or more valves with different functions, chosen from the following: non-return valve, discharge valve, flow regulator valve and maximum pressure valve.

The invention is described in detail hereinafter with the aid of the accompanying figures which show one embodiment thereof by way of non-exclusive example.

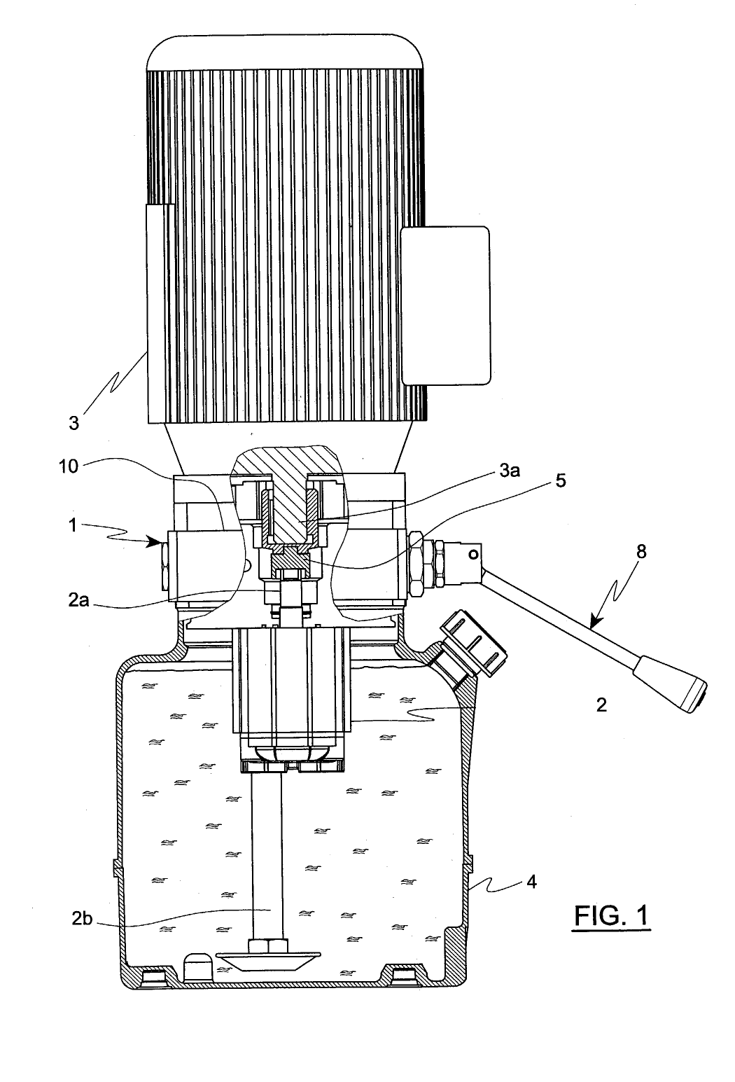

FIG. 1 shows a power unit comprising the valve assembly of the invention.

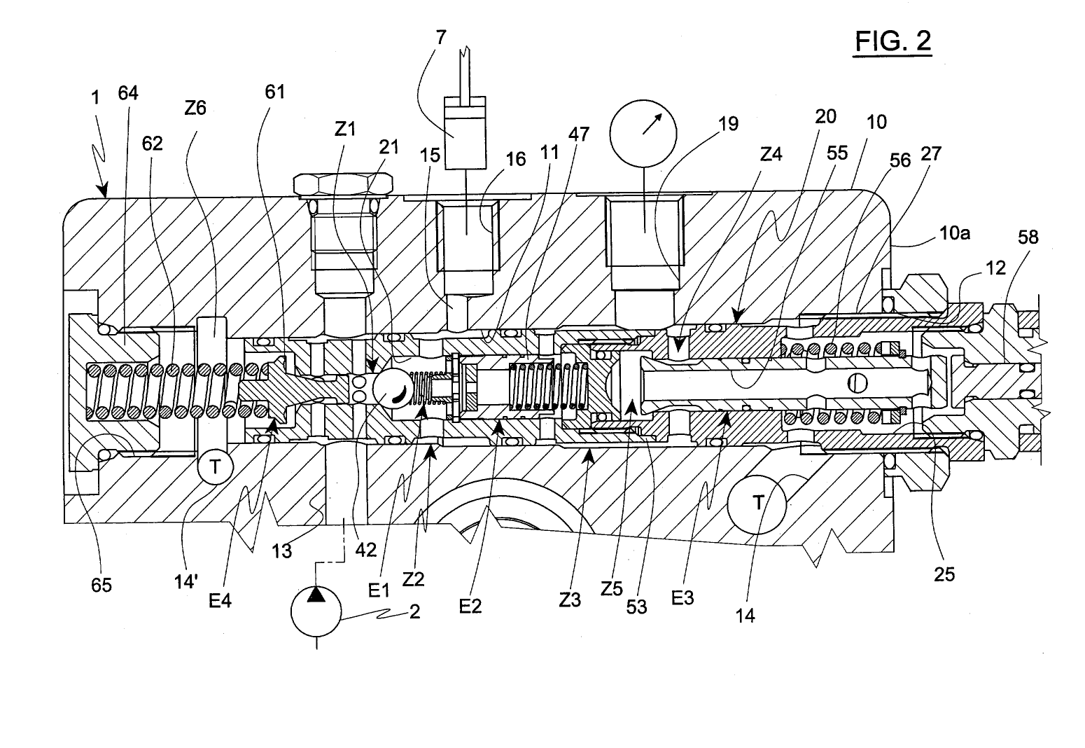

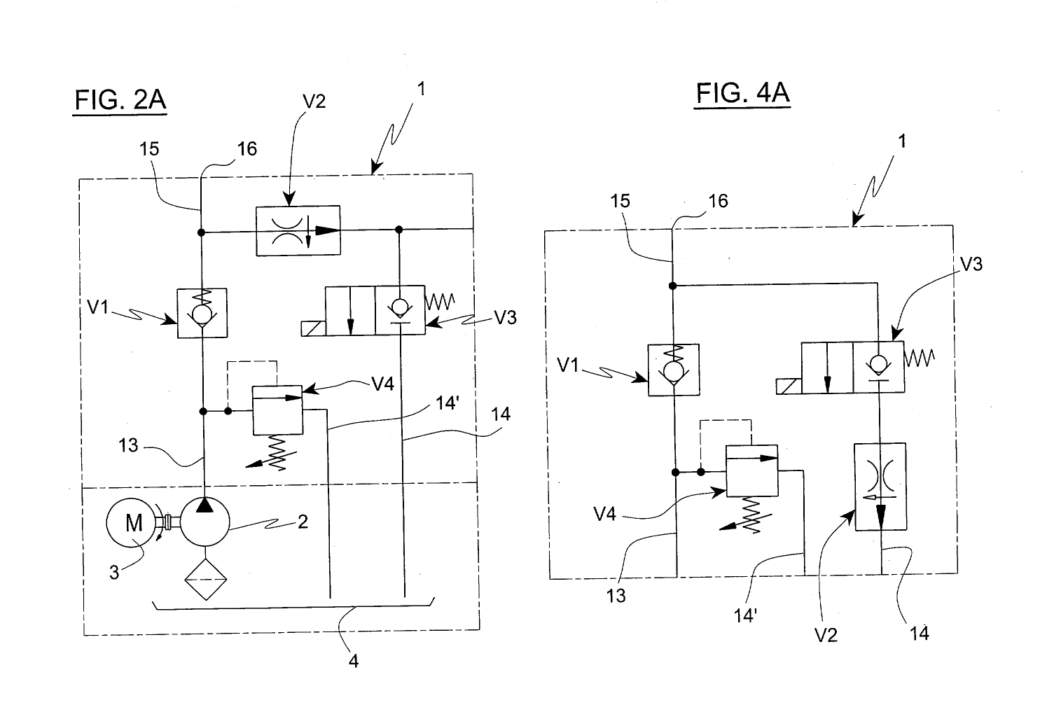

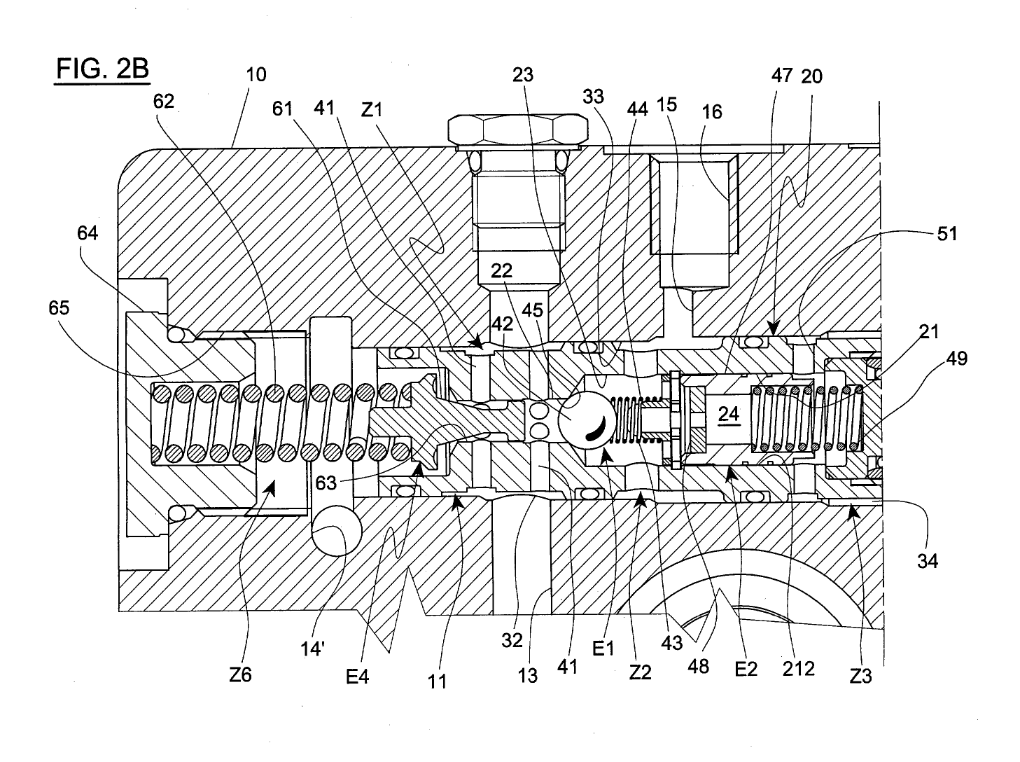

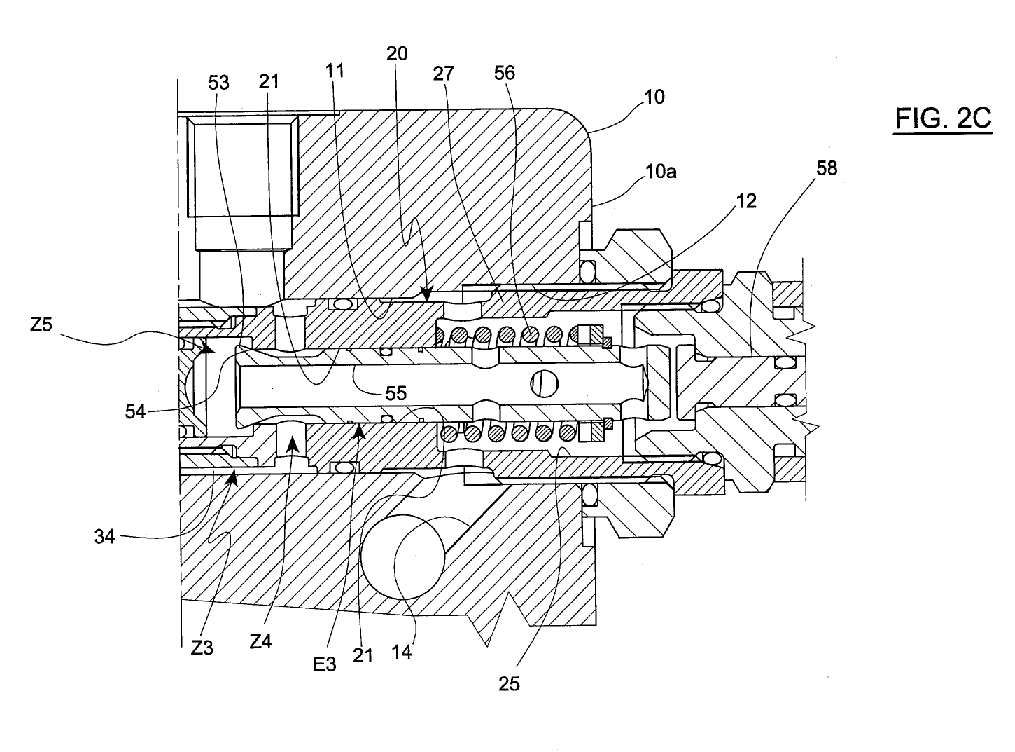

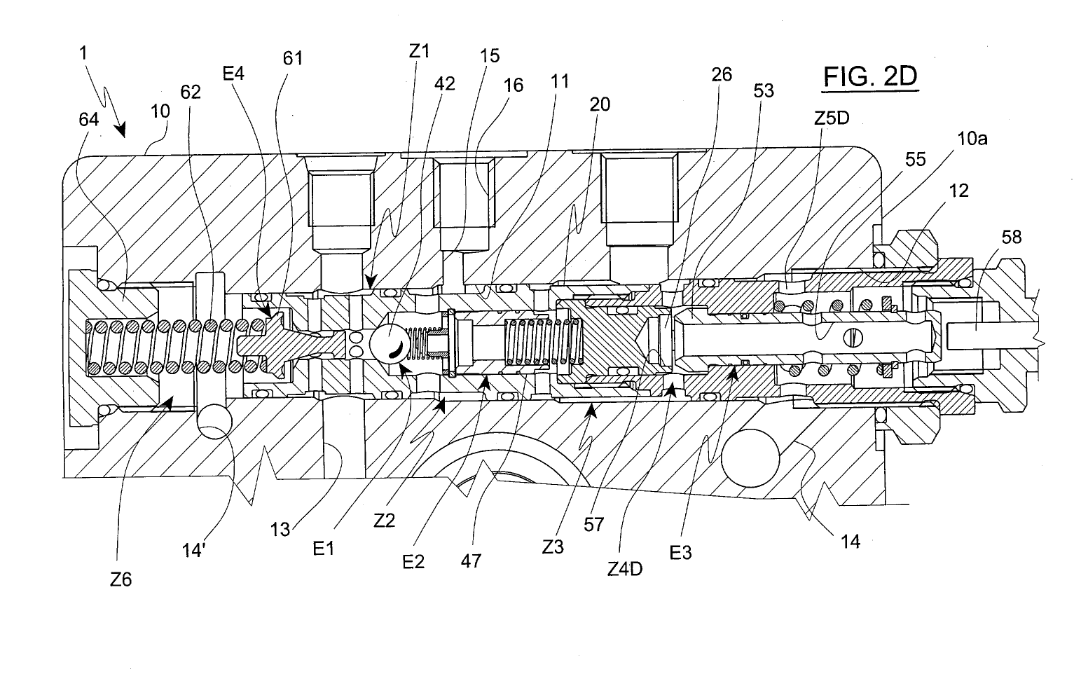

FIG. 2 is a section on the longitudinal axial plane through a first embodiment of the valve assembly according to the invention (in which the discharge valve is of normally closed type).

FIG. 2A shows the scheme of the hydraulic circuit formed from the entire power unit comprising the valve assembly of FIG. 2.

FIGS. 2B and 2C show two respective parts of FIG. 2 on an enlarged scale.

FIG. 2D shows the same valve assembly as FIG. 2, in which the discharge valve is of normally open type.

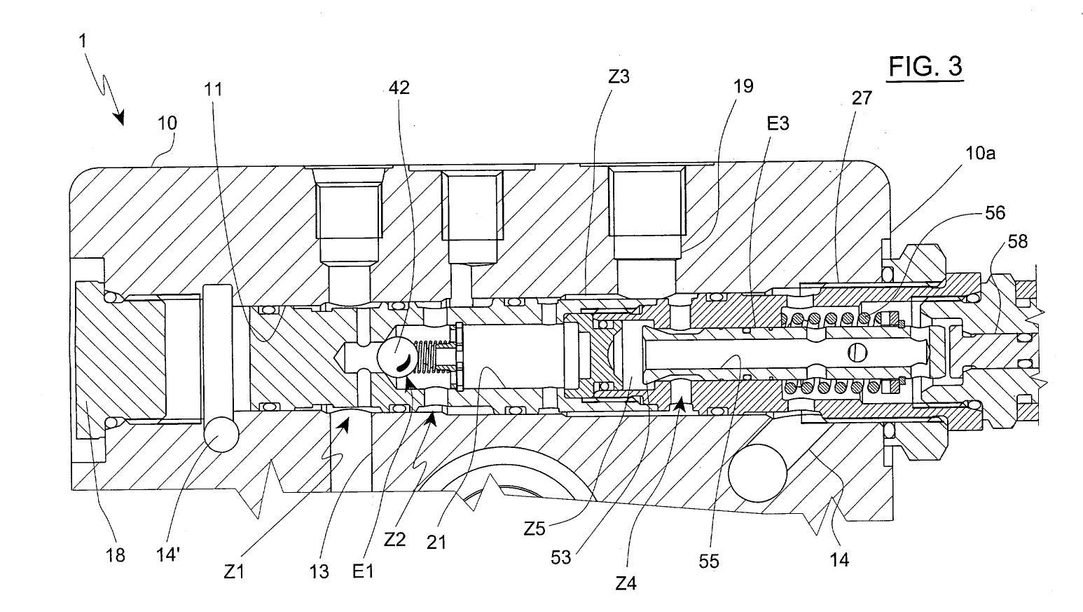

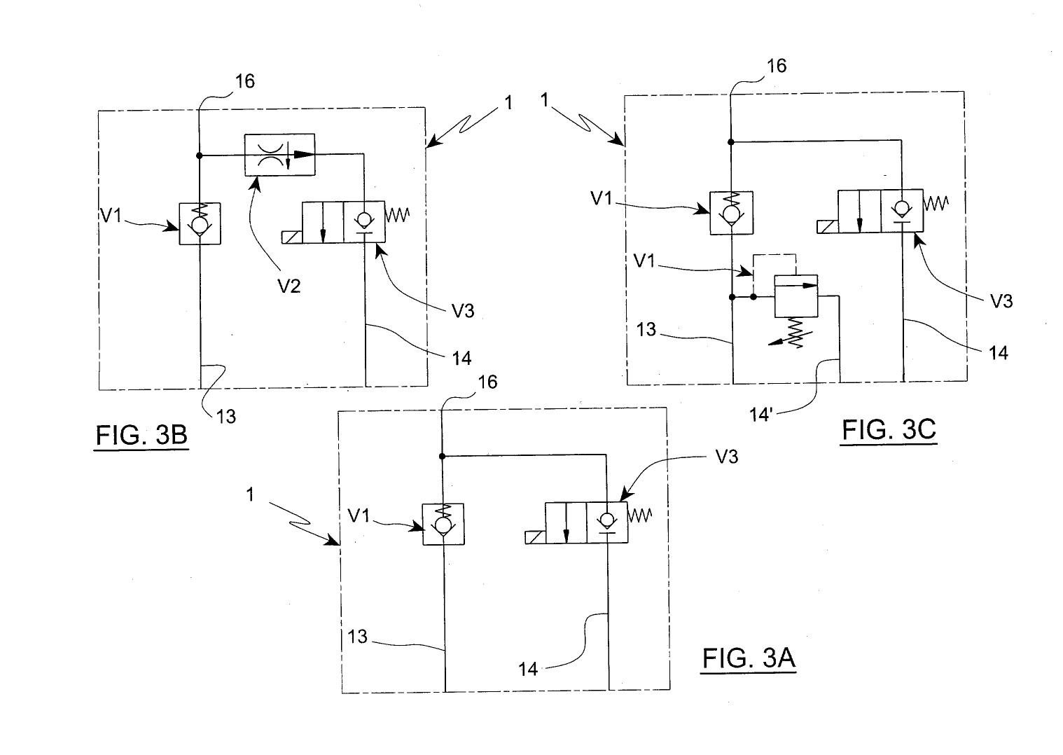

FIG. 3 shows a possible variant of the valve assembly of FIG. 2.

FIG. 3A shows the scheme of the hydraulic circuit formed from the valve assembly of FIG. 3.

FIGS. 3B and 3C show the schemes of two possible variants (not illustrated in the figures) of the valve assembly of FIG. 2.

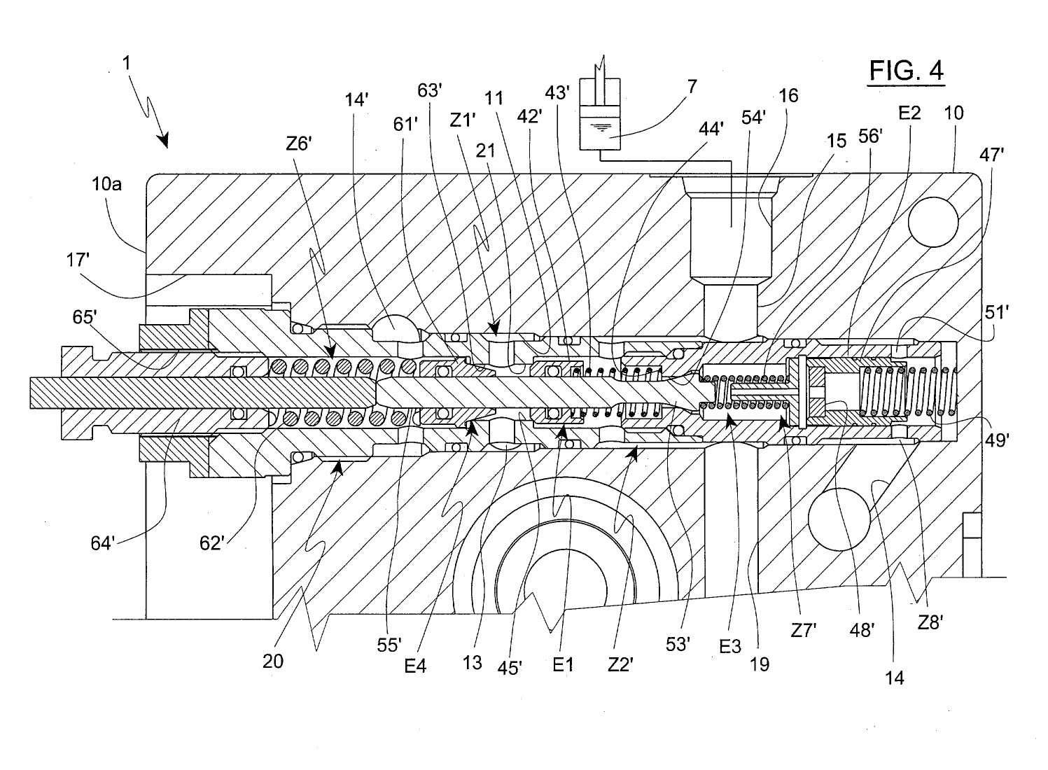

FIG. 4 is the section on the plane II-II of FIG. 1 through a second embodiment of the valve assembly according to the invention.

FIG. 4A shows the scheme of the hydraulic circuit formed from the valve assembly of FIG. 4.

FIG. 1 shows an entire power unit comprising a complex valve assembly of the invention (indicated overall by 1), a pump 2 of the external gear type (the type usually used in power units), an electric motor 3 for operating the pump 2, and a reservoir 4 for the operating liquid (oil). The assembly 1 comprises a one-piece body 10, in particular of parallelepiped shape, which also acts as the element for its fixing to the motor 3, to the pump 2 and to the reservoir 4. The shaft 3a of the motor 3 is coupled to the shaft 2a of the pump 2 by a coupling joint 5 inserted through a through hole provided in the one-piece body 10. The pump 2 draws oil from the chamber of the reservoir 4 via a suction pipe 2b.

With reference to the first embodiment, shown in FIG. 2, the one-piece body comprises, in its interior, a single cylindrical main cavity 11 (having portions of different diameters) of rectilinear axis and communicating, via an outer mouth 12, with at least one outer face 10a of the one-piece body 10, and also comprises a number of first channels 13, 14 and 15, all communicating with the main cavity 11 and connected respectively to the delivery side of the pump 2, to the discharge “T” (i.e. to the chamber of the reservoir 4), and to at least one user take-off 16 connectable to a user means 7 (shown schematically in the figures).

Into the one-piece body 10 there is inserted a cartridge 20, in the form of a cylindrical tube piece (having portions with different diameters), having a second axial cavity 21 coaxial with the main cavity 11 and with its cylindrical outer surface engaging the surface of the main cavity to create, between its outer surface and the surface of the main cavity 11, communication passages (described hereinafter) between said first channels 13-15. For ease of manufacture/assembly, the cartridge 20 is formed in two pieces, one to the right and one to the left, joined rigidly together.

Into the interior of the second cavity 21 there are inserted valve elements arranged to define, in combination with the cavity itself, at least two or more valves with different functions, chosen from the following: non-return valve V1, flow regulator valve V2, discharge valve V3 and maximum pressure valve V4.

Said valve elements are aligned in succession within the interior of the second valve 21.

In particular, within the main cavity 11 and within the cartridge 20 there remains defined a hollow liquid entry zone Z1 comprising an axial chamber 22 forming part of the second cavity 21 and communicating, via radial channels 41, with an annular chamber 32 provided between the surface of the main cavity 11 and the outer surface of the cartridge 20, which communicates with the delivery channel 13. This hollow zone Z1 communicates at one end (towards the left) with a second discharge channel 14′ via the maximum pressure valve V4, and at its other end (towards the right) with a region of the second cavity 21 comprising the other valves V2 and V3, via the non-return valve V1.

Within the main cavity 1 and within the cartridge 20 there remains defined a second hollow zone Z2, comprising an axial chamber 23 forming part of the second cavity 21 and communicating with an annular chamber 33 provided between the surface of the main cavity 11 and the outer surface of the cartridge 20, which is in communication with the user take-off 16. In the interior of the cavity 21 there is positioned a first said valve element E1 arranged to define, in combination with the second cavity 21, the non-return valve V1. Specifically, the element E1 comprises a spherical valving member 42 urged by a spring 43 carried and guided by a guide element 44 and arranged to close a port 45 provided in the axial chamber 22, which connects the second hollow zone Z2 to the entry hollow zone Z1.

The present valve V1 operates on the basis that the valving member 42 allows the fluid to pass if this is directed towards the right, whereas it closes the port 45 if the fluid is directed in the opposite direction.

Downstream of the non-return valve V1 there is positioned a second said valve element E2, arranged to define, in combination with the second cavity 21, the flow regulator valve V2. Said element E2 comprises a slider 47 in the form of a sleeve, housed sealedly slidable within the chamber 212 of the second cavity 21, in a position adjacent to the chamber 23; the axial cavity 24 of the slider 47 is closed by a plug 48 having a sized axial communication passage between the chamber 23 (in communication with the user take-off 16), and the cavity 24 itself; this communicates, via a series of radial passages 51 provided within the cartridge 20, with a downstream third hollow zone Z3 defined by an annular chamber 34 provided between the surface of the main cavity 11 and the outer surface of the cartridge 20, which communicates (via the discharge valve V3) with the discharge 14. The slider 47 is arranged to progressively close said radial passages 51 on the basis of its axial position, which is subjected to the action of a spring 49 opposing its downstream movement.

The present valve V2 operates on the basis of the known fact that the pressure drop which the fluid undergoes in passing through the hole in the plug 48, in relation to the thrust of the spring 49, determines the axial position of the slider 47 such that the flow rate of the fluid leaving the valve is substantially constant whatever its entering flow rate.

Downstream of the valve V2 there is positioned a third valve element E3 which, in combination with the second cavity 21, defines a discharge valve V3, the third element E3 being in communication with the outer mouth 12 to enable the valve to be operated by means 8 positioned on the outer face 10a.

In the embodiment shown in FIG. 2, within the cartridge 20 there remain defined a fourth hollow zone Z4 communicating with the zone Z3 and with the user take-off 16, and a fifth hollow zone Z5 communicating with the discharge 14. The third valve element E3 comprises a valving member 53 operable via the outer mouth 12 to open and respectively close a port 54, provided in the second cavity 21, which connects the fourth hollow zone Z4 to the fifth hollow zone Z5.

In detail, the fourth hollow zone Z4 communicates directly with the third hollow zone Z3 (this communicating with the user take-off 16 via the valve V2), the valving member 53 possessing an inner channel 55 which connects the fifth hollow zone Z5 to the discharge channel 14 via, in the interior of the cartridge 20, an intermediate chamber 25 housing a spring 56 which normally maintains the valving member 53 in the position in which it closes the port 54.

The present valve V3 is normally closed and allows the liquid to pass when the valving member 53 is moved to the right.

Although the valve V3 shown in FIG. 2 is of the normally closed type, it can be of the normally open type, as illustrated in FIG. 2D. In this case, within the main cavity 11 and the cartridge 20 there remains defined a fourth hollow zone Z4D comprising a chamber 26 communicating with the third hollow zone Z3 (and consequently with the user take-off 16), within the cartridge 20, at the rear portion of the valving member 53, there remaining defined a fifth hollow zone Z5D in communication with the discharge 14.

The inner channel 55 of the valving member 53 is normally open and maintains the communication between the two zones Z4D and Z5D. Within the chamber 26 there is provided a seat 57 which closes the inner channel 55 when the valving member 53 is moved towards the left, overcoming the counteracting force of the spring 56 and hence closing the passage for the liquid.

In both cases (both for the normally closed version and for the normally open version), the valving member 53 is operable from the outside, for example by a push rod 58, itself operable by any known means (not shown in the figures) for operating this type of valve (a manual lever, a linear or rotary electromagnetic actuator, an external hydraulic or air command, etc.).

At the left end of the hollow entry zone Z1 there is positioned a fourth valve element E4, arranged to define, in combination with the second cavity 21, a maximum pressure valve V4.

The element E4 comprises a valving member 61 urged by a spring 62 to close a passage port 63 provided in the second cavity 21 to connect said hollow entry zone Z1 to a sixth hollow zone Z6 provided partly within the cavity 21 and communicating with the second discharge channel 14′.

The spring 62 is compressed by an abutment part 64, which also closes the left end of the main cavity 11; the part 64 is screwed into a seat provided in the outer mouth 65 and its rotation in one direction or the other produces a variation in the axial position of that part to hence adjust the degree of precompression of the spring 62.

The cartridge 20 is subjected to axial movements within the main cavity 11 and is constrained thereto by a (right) end threaded portion 27 screwed into a corresponding threaded seat provided at the right end of the main cavity 11. The portion 27 is accessible from the outside and is operable in the manner of an adjustment element to vary the axial position of the cartridge 20 and hence vary the axial position of the port, to hence finally adjust the degree of precompression of the spring 62.

The hydraulic scheme for the valve assembly of FIG. 2 is shown in FIG. 2A.

During operation, the operating liquid leaving the pump 2 is fed through the channel 13 to the hollow entry zone Z1. Here, if its pressure does not exceed the set value of the spring 62, the valve V4 remains closed and the liquid passes into the hollow zone Z2 after passing through the port 45 of the non-return valve V1. If the pressure in the hollow zone Z1 instead exceeds the set value, the liquid passes directly to discharge via the valve V4.

From the hollow zone Z2, assuming that the discharge valve V3 is closed, the liquid is fed to the user means 7 via the user take-off 16. Hence during this stage the liquid does not pass through the valves V2 and V3.

If instead the valve V3 is open, the liquid, whether originating from the user take-off or from the delivery 13, is fed to discharge 14 by passing through the flow regulator valve V2 and then through the discharge valve V3.

The valve element E2 is coupled to the cartridge 20 in such a manner as to enable it, at choice, to be either inserted into or not inserted into the cartridge 20. In this second case, shown in FIG. 3, the regulator valve V2 is lacking and the chamber 212 is completely free to directly connect the hollow zone Z2, lying immediately downstream of the valving member 42 of the valve V1, to the hollow zone Z3. When only the valve V2 is lacking, the hydraulic scheme of the valve assembly is that shown in FIG. 3C.

The valve assembly 1 can also be modified in the sense of not including the maximum pressure valve V4 (as shown in FIG. 3). In this case, besides lacking the valving member 61 and the spring 62, the left end portion of the cartridge 20 is closed by a plug 18.

When only the valve V4 is lacking, the hydraulic scheme of the valve assembly is as shown in FIG. 3B.

When both the valve V2 and the valve V4 are lacking, as in the case shown in FIG. 3, the hydraulic scheme of the valve assembly is as shown in FIG. 3A.

FIG. 4 shows a second embodiment of the valve assembly 1 (with the valve V3 normally closed), in which equivalent parts are indicated by the same reference numerals as the preceding figures.

Again there is provided a similar hollow liquid entry zone Z1′, in communication with the delivery channel 13.

This hollow zone Z1′ communicates at one end (towards the left) with a second discharge channel 14′ via the maximum pressure valve V4, and at the other end (towards the right) with a region of the second cavity 21 comprising the other valves V2 and V3, via the non-return valve V1.

A similar second hollow zone Z2′ is provided, communicating with the user take-off 16. Within the cavity 21 there is provided a first said valve element E1 arranged to define, in combination with the second cavity 21, the non-return valve V1. The element E1 comprises a valving member 42′ urged by a spring 43′ held by an abutment element 44′ and arranged to close a port 45′ provided in the second cavity 21 to connect the second hollow zone Z2′ to the hollow entry zone Z1′.

In contrast to the situation of FIG. 2, immediately downstream of the valve V1 there is positioned the third valve element E3 which in combination with the second cavity 21 defines a discharge valve V3, said third element E3 communicating with an external mouth 17′ to enable the valve to be operated by means located on the other face 10a of the one-piece body 10.

Within the cartridge 20 there remains defined a hollow zone Z7′ communicating with the discharge 14 and connected, via a passage port 54′ provided in the second cavity 21, to said hollow zone Z2′ (this communicating with the user take-off 16). The third valve element E3 comprises a valving member 53′ operable via the outer mouth 12 to close and respectively open the passage port 54′, and subjected to the action of a spring 56′.

To operate the valving member 53′, there is provided a rod 55′ (which in the illustrated embodiment is formed as two successive adjacent rod segments) slidable coaxially within the second cavity 21 to act directly on the valving member joined to it, and having an end which emerges and projects from the one-piece body 10 to be operated from the outside by any known means (not shown) for operating this type of valve (a manual lever, a linear or rotary electromagnetic actuator, an external hydraulic or air command, etc.).

The valving members 42′ and 53′ of the valve elements E1 and E3 are disposed aligned in succession within the second cavity 21, the rod 55′ passing through them, able to slide mutually under sealed conditions.

Downstream of the discharge valve V3 there is positioned a valve element E2 which in combination with the second cavity 21 defines the flow regulator valve V2. Said element E2 is substantially identical to that shown in FIG. 3 and comprises a slider 47′ in the form of a sleeve, housed sealedly slidable within the second cavity 21, in a position adjacent to and communicating with the hollow zone Z7′; the axial cavity of the slider 47′ is closed by a plug 48′ having a sized axial communication passage between the hollow zone Z7′ (in communication with the user take-off 16 when the valve V3 is open), and the slider cavity; this communicates, via radial passages 51′ provided within the cartridge 20, with a further downstream hollow zone Z8′ defined by an annular chamber provided between the surface of the main cavity 11 and the outer surface of the cartridge 20, which is in direct communication with the discharge 14. As in the embodiment shown in FIG. 2, the slider 47′ is arranged to progressively close said radial passages 51′ on the basis of its axial position, which is subjected to the action of a spring 49′ opposing its movement towards the right.

The hydraulic scheme of the valve assembly illustrated in FIG. 4 is shown in FIG. 4A and differs from that of FIG. 2A only in that, when the valve V3 is open, the valve V2 is positioned downstream of it.

To the left of the hollow entry zone Z1′ there is positioned the fourth valve element E4, arranged to define, in combination with the second cavity 21, the maximum pressure valve V4.

The element E4 comprises a valving member 61′ urged by a spring 62′ to close a passage port 63′ provided in the second cavity 21 to connect said hollow entry zone Z1′ to the sixth hollow zone Z6′, which communicates with the second discharge channel 14′.

The spring 62′ is compressed by an abutment part 64′, which also closes the left end of the main cavity 11; the part 64′ is screwed into a seat provided in the outer mouth 65′ and its rotation in one direction or the other produces a variation in the axial position of that part to hence adjust the degree of precompression of the spring 62′.

In addition to said channels 13, 14, 14′, 15, other channels can be provided, for example a channel 19 for a pressure gauge.

The invention can also find application independently of a power unit, for example to form in-line valve blocks.

Numerous modifications of a practical and applicational nature can be made to the invention, but without leaving the scope of the inventive idea as claimed below.

1. A complex valve assembly for hydraulic circuits, characterised by comprising:
a one-piece body (10) having in its interior a single axial cylindrical main cavity (11) of rectilinear axis, communicating via an outer mouth with at least one outer face (10a) of the one-piece body (10), and first channels (13, 14, 14′, 15) communicating with said main cavity (11) and connected to the delivery side (13) of a liquid pressurizing pump, to the discharge, and to at least one user take-off (16) respectively;
inserted into the one-piece body (10), a cylindrical cartridge (20) having an axial second cavity (21) coaxial with the main cavity (11), which cartridge engages the surface of the main cavity (11) and is arranged to create, between its own cylindrical outer surface and the surface of the main cavity (11), passages providing communication between said first channels (13, 14, 14′, 15);
valve elements (E1-E4), inserted into the second cavity (21) and arranged to define, in combination with this latter, at least two or more valves with different functions, chosen from the following: non-return valve (V1), flow regulator valve (V2), discharge valve (V3) and maximum pressure valve (V4).

2. A valve assembly as claimed in claim 1, characterised in that said valve elements (E1-E4) are positioned aligned in succession in the interior of the second valve (21).

3. A valve assembly as claimed in claim 1, characterised in that within the main cavity (11) and within the cartridge (20) there remains defined a hollow liquid entry zone (Z1) fed by the pump delivery (13) and communicating at one end with the discharge channel (14′) via the maximum pressure valve (V4) and at the other end with a region of the second cavity (21) comprising the other valves (V2-V3), via a non-return valve (V1).

4. A valve assembly as claimed in claim 1, characterised in that within the main cavity (11) and within the cartridge (20) there remains defined a second hollow zone (Z2, Z2′) communicating with the user take-off (16), and further comprises a first said valve element (V4) arranged to define, in combination with the second cavity (21), a non-return valve (V1) comprising a valving member (42, 42′) urged by a spring and arranged to close a port (45, 45′) provided in the second cavity (21) and connecting said second hollow zone (Z2, Z2′) to a hollow entry zone in communication with the pump delivery.

5. A valve assembly as claimed in claim 1, characterised by comprising a second valve element (E2), arranged to define, in combination with the second cavity (21), a flow regulator valve (V2), which element (E2) comprises a slider (47, 47′) in the form of a sleeve having a sized axial passage of communication between a hollow zone (Z2, Z7′) of the second cavity (21), itself in communication with the user take-off (19), and a further hollow zone (Z3, Z8′) of the second cavity (21), itself in communication with the discharge (14), said slider (47, 47′) being sealedly slidable within the second cavity (21) and subjected to the opposing action of a spring, and being arranged to progressively close, as a function of its axial position, at least one passage (51, 51′) provided within the cartridge (20) to connect that region of the second cavity (21) lying downstream of the sized hole to said further hollow zone (Z3, Z8′).

6. A valve assembly as claimed in claim 5, characterised in that the second axial cavity (21) comprises an axial chamber (212) arranged to sealedly and slidably house said third valve element (E3), whereas if this latter is not present the axial chamber (212) directly connects said zones (Z2, Z3, Z7′, Z8′) together.

7. A valve assembly as claimed in claim 1, characterised by comprising a third valve element (E3), arranged to define, in combination with the second cavity (21), a discharge valve (V3), said third valve element (E3) communicating with said outer mouth to enable the valve (V3) to be operated by means located on the outer face of the one-piece body (10).

8. A valve assembly as claimed in claim 7, characterised in that within the main cavity (11) and the cartridge (20) there remain defined a hollow zone (Z4, Z4D, Z4′) communicating with a user take-off (16) and a further hollow zone (Z5), (Z5D, Z8′) communicating with the discharge (14), said valve element (E3) comprising a valving member (53, 53′) operable via the outer mouth and arranged to close and respectively open a port (54, 54′) provided in the second cavity (21) to connect said two zones together.

9. A valve assembly as claimed in claim 8, said valve elements (E1-E4) being positioned aligned in succession within the second cavity (21), characterised by comprising a rod (55′) slidable coaxially within the second cavity (21) and acting on the valving member (53′) open/close said port, at least one said valve element (E1, E4) being sealedly traversed coaxially by said rod (55′).

10. A valve assembly as claimed in claim 3, characterised by comprising a fourth valve element (E4) arranged to define, in combination with the second cavity (21), a maximum pressure valve (V4), and comprising a valving member (61, 61′) urged by a spring (62, 62′) and arranged to close a passage port (65, 65′) provided in the second cavity (21) to connect said hollow entry zone (Z1, Z1′) to another hollow zone (Z6, Z6′) of the second cavity (21a)

11. A valve assembly as claimed in claim 10, characterised in that said spring (62, 62′) is compressed by an abutment part (64, 64′) which is screwed into a seat provided in the outer mouth, the rotation of the abutment part in one direction or the other producing a variation in the degree of precompression of the spring.

12. A valve assembly as claimed in claim 10, characterised in that said cartridge (20) is subjected to axial movements within the main cavity (11) and is constrained thereto by a threaded end portion (27) screwed into a corresponding threaded seat provided at the right end of the main cavity (11) and accessible from the outside, said portion (27) being operable in the manner of an adjustment element to vary the axial position of the cartridge (20) and hence finally adjust the degree of precompression of the spring 62.
